(19) United States
(12) Patent Application Publication
(10) Pub. No.: US 2005/0251984 A1
(43) Pub. Date: Nov. 17, 2005

(54) Methods and apparatus for welding damaged race vehicle frames

(75) Inventor: Robert R. Vickers, Chagrin Falls, OH (US)

Correspondence Address: ESCHWEILER & ASSOCIATES, LLC;NATIONAL CITY BANK BUILDING, 629 EUCLID AVE., SUITE 1210, CLEVELAND, OH, 44114, US

(73) Assignee: Race Weld, Inc.

(21) Appl. No.: 10/972,877

(22) Filed: Oct. 25, 2004

Related U.S. Application Data
(60) Provisional application No. 60/568,662, filed on May 6, 2004.

(51) Int. Cl. B23P 6/00; B23P 19/04

(52) U.S. Cl. 29/402.08; 29/402.11; 29/402.13

(57) ABSTRACT

Methods and apparatus are presented for repairing a damaged vehicle frame section, as well as repair weldments for vehicle frames. The repair apparatus comprises two or more repair sleeve structures with inner surfaces generally conforming to outer surfaces of frame segments that are to be joined, where the sleeve structures are adapted to be located along portions of the frame segment outer surfaces, leaving two or more gaps that expose portions of the frame segment outer surfaces between the repair sleeve structures, so that the repair sleeve structures can then be welded to the frame segments along the gaps.

### REFERENCE TO RELATED APPLICATION

This application claims priority to and the benefit of U.S. Provisional Patent Application Ser. No. 60/568,662, which was filed May 6, 2004, entitled METHODS AND APPARATUS FOR WELDING DAMAGED RACE VEHICLE FRAMES, the entirety of which is hereby incorporated by reference.

### FIELD OF INVENTION

The present invention relates generally to repairing race vehicles and more particularly to methods and apparatus for welding damaged race vehicle frame sections.

### BACKGROUND OF THE INVENTION

Racing vehicles, such as race cars, motorcycles, etc., often include a frame constructed of metal frame sections joined together to form a cage structure to which the engine, wheels, and other vehicle components are mounted. In certain forms of race vehicles, the frame sections are hollow tubes that are joined together to create the frame structure. During a race or in operation of a vehicle in preparation for a race, the race vehicle may be involved on a crash in which one or more of the frame sections are damaged. Such damage can include deformation of one or more frame sections and/or separation of a frame section into two segments, thereby rendering the vehicle inoperable or unsafe. In typical race situations, a race team may have only one vehicle at a particular race, wherein damaged race vehicles need to be repaired at the race site using portable welding equipment in order to participate in or continue the race. Accordingly, there is a continuing need for improved methods and apparatus for repairing race vehicles and damaged frame sections thereof.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The invention relates to methods and apparatus for repairing a damaged vehicle frame section, wherein repair sleeve structures are provided with inner surfaces generally conforming to outer surfaces of frame segments that are to be joined. Two or more repair sleeve structures are situated along portions of the frame segment outer surfaces, leaving gaps that expose portions of the frame segment outer surfaces between the repair sleeve structures, so that the repair sleeve structures can then be welded to the frame segments along the gaps. The invention may be advantageously employed to facilitate expedited repair of damaged sections of race vehicle frames at track-side weld stations of a race site in order to participate in or continue a race.

In accordance with one aspect of the invention, a method is provided for repairing a race vehicle frame section. The method comprises locating first and second frame segments of a frame section proximate one another along an axis. The method further comprises providing first and second repair sleeve structures having inner surfaces that generally conform to outer surfaces of the frame segments, and locating the repair sleeve structures along portions of the outer frame segment surfaces, leaving first and second gaps that expose portions of the outer frame segment surfaces between the sleeve structures. The method further comprises welding the repair sleeve structures to the frame segments along the gaps.

In accordance with another aspect of the invention, apparatus is provided for repairing a damaged vehicle frame section. The apparatus comprises first and second repair sleeve structures having inner surfaces that generally conform to outer surfaces of first and second frame segments to be joined in repairing a frame section. The repair sleeve structures are adapted to be located along portions of the outer surfaces of the frame segments with portions of the inner surfaces of the repair sleeve structures engaging the outer surfaces of the frame segments while leaving gaps that expose portions of the outer surfaces of the frame segments between the repair sleeve structures.

In accordance with yet another aspect of the invention, a repair weldment is provided for a vehicle frame section. The repair weldment comprises first and second repair sleeve structures individually having an inner surface generally conforming to outer surfaces of first and second frame segments of a vehicle frame section. The first repair sleeve structure is located along a portion of the outer surfaces of the first and second frame segments with at least a portion of the inner surface of the first repair sleeve structure engaging the outer surfaces of the frame segments. The second repair sleeve structure has an inner surface generally conforming to the outer surfaces of the frame segments, and is located along another portion of the outer surfaces of the segments with at least a portion of the inner surface of the second repair sleeve structure engaging the outer surfaces of the first and second frame segments. The repair sleeve structures are located so as to define first and second gaps therebetween, and are welded to the frame segments to provide a repair weldment for the vehicle frame section.

The following description and annexed drawings set forth in detail certain illustrative aspects and implementations of the invention. These are indicative of only a few of the various ways in which the principles of the invention may be employed.

### BRIEF DESCRIPTION OF THE DRAWINGS

FIG. 1 is a partial perspective view illustrating a race vehicle frame with two damaged frame sections;

FIG. 2 is a partial perspective view illustrating the race vehicle frame of FIG. 1 following repair using the apparatus and methods of the present invention;

FIG. 3 is a partial side elevation view illustrating two frame segments joined by welding using repair sleeve structures in accordance with the invention;

FIGS. 4 and 5 are a partial end elevation views in section taken along section lines 4-4 and 5-5, respectively, of FIG. 3 illustrating weld joints that join repair sleeve structures to a frame segment along two gaps between the repair sleeve structures;

FIG. 6 is a partial end elevation view in section illustrating repair sleeve structures clamped along opposite lateral sides of frame segments being joined by welding; and

FIG. 7 is a perspective view illustrating two exemplary repair sleeve structures in accordance with the present invention.

### DETAILED DESCRIPTION OF THE INVENTION

One or more implementations of the present invention will now be described with reference to the attached drawings, wherein like reference numerals are used to refer to like elements throughout. The invention provides improved apparatus and methods for repairing damaged race vehicle frames and sections thereof, which may be employed in association with any type of race vehicles, including but not limited to race cars, motorcycles, boats, planes, etc.

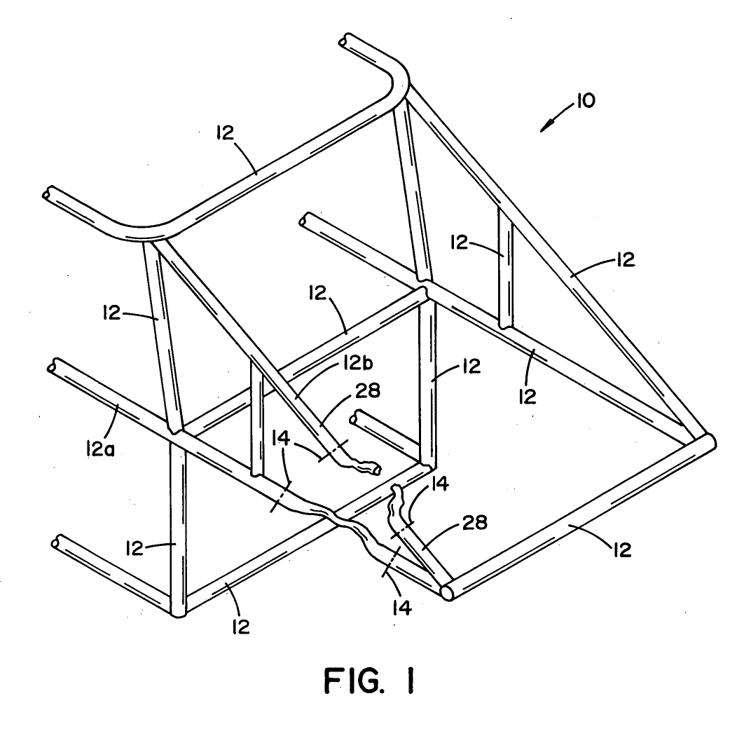

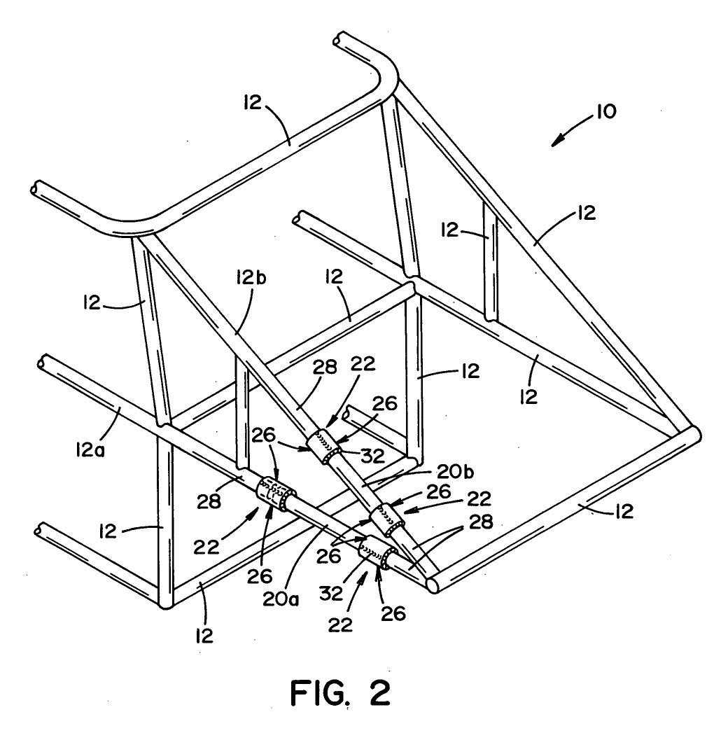

FIG. 1 illustrates a portion of a damaged race vehicle frame 10 having a number of interconnected frame sections 12 joined together to form a cage structure for a race car, and FIG. 2 illustrates the frame 10 following repair in accordance with the present invention. In the exemplary vehicle frame 10, the individual sections 12 are generally cylindrical metallic hollow tubes having circular inner and outer surfaces, wherein some of the sections 12 are straight and some have straight portions and bent or curved portions, although the various aspects of the invention may be employed with any weldable frame sections having any outer shapes or surface contours, including but not limited to sections having circular, rectangular, polygonal, or other cross-sectional profiles. As illustrated in FIG. 1, the vehicle frame 10 has been damaged, wherein a first frame section 12a has been deformed and a second section 12b has been severed into two segments 28.

In a race situation, it is desirable to repair the damaged frame sections 12a and 12b in an expedited fashion, using only portable welding equipment and other tools that are readily available in a track-side repair station at a race facility site, in order to participate in or to continue a race. In order to repair the damaged frame 10, the damaged frame sections 12a and 12b are initially cut or segmented along the cut lines 14 of FIG. 1 using a plasma cutting torch (not shown) or other means, and the severed or deformed portions thereof are removed and discarded.

In FIG. 2, the frame 10 is illustrated following repair in accordance with the present invention. In the illustrated implementation of the invention, substitute frame segments 20a and 20b are spliced between the remaining segments 28 of the damaged frame sections 12a and 12b, respectively, wherein the splice segments 20 may be of any suitable weldable material within the scope of the invention, and need not be the same material as the frame sections 12. Alternatively, two original segments 28 of a damaged frame section 12 may be repaired using the apparatus and methods of the invention, for instance, when two separated segments 28 can be aligned along an axis with only a small spacing distance therebetween.

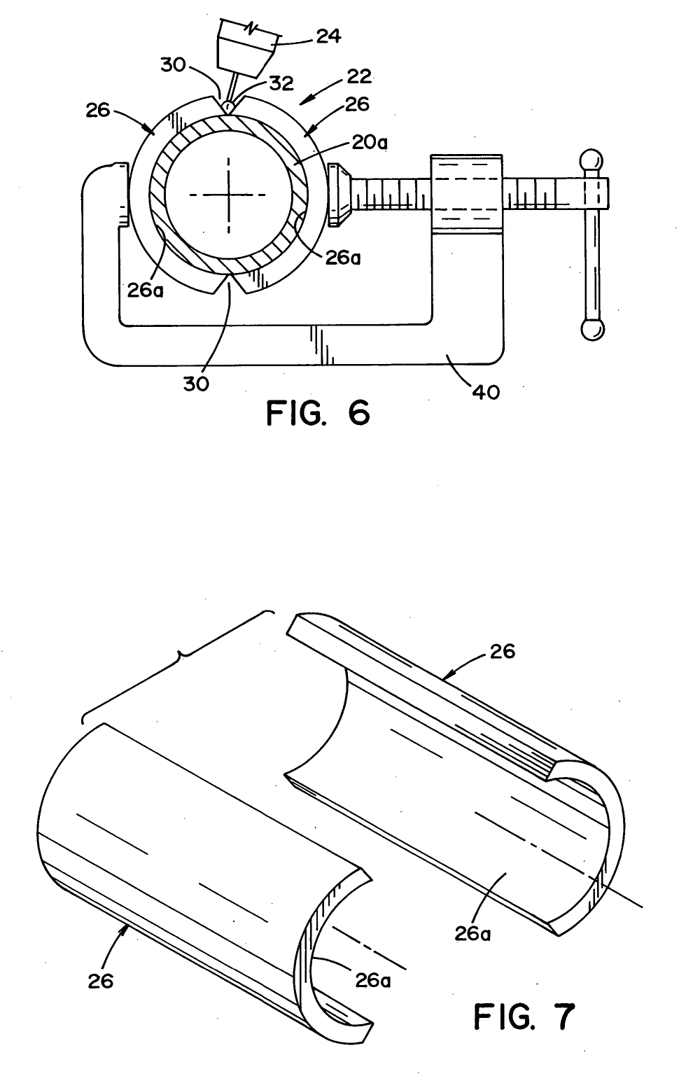

In the example of FIG. 2, each splice segment 20 and the corresponding original segments 28 of the damaged sections 12a and 12b are located along the axis of the original frame section 12, wherein the cut lines 14 of FIG. 1 above may be located such that the remaining original sections 28 are situated along the original section axis, or alternatively, one or both of the cut segments 28 may need to be bent or otherwise redirected along the section axis prior to welding. Repair weldments 22 are then formed at each end of the splice segments 20 using a portable welder 24 (FIG. 6 below) and repair sleeve structures 26 of the invention, as illustrated and described further below, wherein any type of welding equipment and/or weld types (e.g., metal inert gas (MIG), tungsten inert gas (TIG), etc.) within the scope of the present invention.

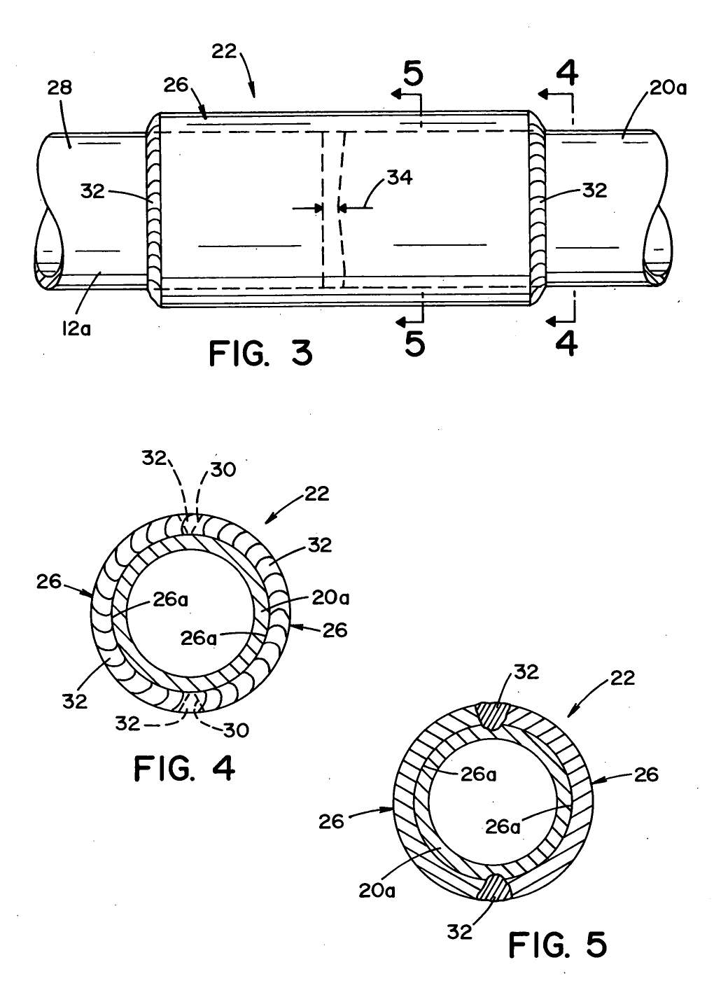

Referring also to FIGS. 3-7, one aspect of the invention provides apparatus for repairing a damaged vehicle frame section 12, including two or more repair sleeve structures 26. The sleeve structures 26 may be of any suitable weldable materials, such as metals or the like, and may be of any suitable shape having inner surfaces 26a generally conforming to outer surfaces the frame segments 20, 28 being joined. In the illustrated example, the repair sleeve structures 26 have generally arcuate inner surfaces 26a that conform to arcuate outer surfaces of cylindrical frame segments 20, 28, as illustrated in FIGS. 4-7. However, other repair sleeve structures 26 are possible within the scope of the invention, including but not limited to structures having inner surfaces 26a generally conforming to outer surfaces of square, rectangular, polygonal, or other frame segments 20, 28.

Furthermore, strict conformance of the sleeve structure inner surfaces 26a with the outer surfaces of the segments 20, 28 being joined is not required, wherein any generally conforming relationship between the sleeve inner surface 26a and the outer surface of the frame segments 20, 28 is contemplated in which all or portions of the repair sleeve inner surfaces 26a engage the outer surfaces of the segments 20, 28 while leaving gaps 30 (FIG. 6) that expose portions of the frame segments 20, 28 between the repair sleeve structures 26.

In addition, while the illustrated repair sleeve structures 26 are substantially identical to one another, other implementations of the invention are possible, wherein sleeve structures 26 are dissimilar. For instance, while the illustrated sleeve structures 26 each extend slightly less than about 180 degrees around the periphery of the segments 20, 28 to be joined, other examples are possible, wherein one such sleeve structure 26 extends around much less than 180 degrees, while the other structure 26 extends around greater than 180 degrees of the circular periphery. In this regard, the angular extension of the repair sleeve structures 26 around the periphery of the frame segments 20, 28 may be tailored so as to provide a desired gap distance between sleeve structures 26 during welding, whereby the strength and integrity of the resulting weldment 22, and the suitability of the gap distance for a particular type of welder 24 or weld process can be adjusted.

Moreover, more than two sleeve structures can be used, which may, but need not, be similar to one another, wherein all such variant implementations are contemplated as falling within the scope of the invention. It is noted that for a given type or types of original frame sections 12, a race team may advantageously construct and stock a number of corresponding repair sleeve structures for expeditious track-side repair at a race site, so as to mitigate significant down-time and/or to avoid missing a race altogether, without having to maintain a separate back-up vehicle.

In forming a weldment 22 of the invention, two or more repair sleeve structures 26 are situated along portions of outer surfaces of the frame segments 20, 28 being joined, leaving gaps 30 between the sleeve structures 26, wherein the frame segments and the sleeve structures are welded to one another along the gaps. FIG. 6 illustrates a welder 24 creating a weld bead 32 within one such gap 30 to join the sleeve structures 26 to the frame splice segment 20a, wherein the weld 32 is continued to the original segment 28 along the frame section 12a of FIG. 2.

In addition, the illustrated weld 32 may, but need not, be continued around all or a portion of the periphery of the ends of the repair sleeve structures 26 to join the sleeve structure ends to the frame segments 20, 28. In this regard, it is noted that the provision of the repair sleeve structures 26 of the invention allows the weldment 22 to include weld connection of the structures 26 with the segments 20, 28 between the sleeve structure ends (e.g., in the gaps 30) in addition to weld connection at the ends themselves, wherein a more robust weldment 22 may be obtained than would be possible by merely providing a single cylindrical sleeve welded only at the ends to the segments 20, 28. Furthermore, in this example, the repair sleeve structures 26 are clamped to the segments 20, 28 using a C-clamp 40 during welding, although other clamping means may alternatively be employed, wherein clamping is not a strict requirement of the present invention.

While the illustrated sleeve structures 26 are such that the resulting gaps 30 are generally straight and extend generally parallel to the axis of the frame section 12 being repaired, other implementations are possible wherein the sleeve structures are shaped such that the resulting weld gaps are non-linear, wherein all such variant implementations are contemplated as falling within the scope of the invention and the appended claims.

FIGS. 3-5 illustrate one exemplary weldment 22 using the sleeve structures 26 of the invention in the frame 10 of FIG. 2, wherein FIGS. 4 and 5 illustrate sections taken along section lines 4-4 and 5-5, respectively, of FIG. 3. As can be seen in the example of FIG. 3, the frame segments 28 and 20a being joined have ends facing one another that are spaced from one another by a small distance 34, although other implementations are possible where the segments 20, 28 touch or engage one another. As illustrated in FIG. 5, the outer surface of the resulting weld 32 in the gaps 30 may be generally conformal to the shape or contour of the outer surfaces of the sleeve structures 26, although this is not a requirement of the invention. Furthermore, the weld joint 32 may extend inwardly within the dimensions of the joined segments 20, 28, wherein the weld joint 32 may be comprised wholly or partially of materials originally forming the segments 20, 28, and/or the sleeve structures 26, or the welder 24 or an operator may add additional weld material, wherein the resulting weld 32 may comprise constituent materials from any or all of these sources.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A method of repairing a race vehicle frame section, the method comprising:
locating first and second frame segments of a frame section proximate one another along an axis, the first frame segment having a first frame segment end and a first outer surface with a first shape, the second frame segment having a second frame segment end facing the first frame segment end and a second outer surface with a second shape, the first and second shapes being similar to one another;
providing first and second repair sleeve structures having inner surfaces generally conforming to the first and second outer surfaces of the frame segments;
locating the first repair sleeve structure along first portions of the first and second outer surfaces of the first and second frame segments, at least a portion of the inner surface of the first repair sleeve structure engaging the first and second outer surfaces of the first and second frame segments;
locating the second repair sleeve structure along second portions of the first and second outer surfaces of the first and second frame segments, at least a portion of the inner surface of the second repair sleeve structure engaging the first and second outer surfaces of the first and second frame segments, wherein the first and second repair sleeve structures extend around most of a periphery of the first and second outer surfaces of the first and second frame segments at the first and second frame segment ends, leaving first and second gaps that expose portions of the first and second outer surfaces of the first and second frame segments between the first and second repair sleeve structures; and
welding the repair sleeve structures to the frame segments along the gaps.

2. The method of claim 1, further comprising clamping the repair sleeve structures to the frame segments while welding the repair sleeve structures to the frame segments along the gaps.

3. The method of claim 2, further comprising welding the repair sleeve structures to the frame segments along ends of the repair sleeve structures.

4. The method of claim 3, wherein welding the repair sleeve structures to the frame segments along the gaps comprises:
welding the first repair sleeve structure to the first and second frame segments before locating the second repair sleeve structure along second portions of the first and second outer surfaces of the first and second frame segments; and
welding the second repair sleeve structure to the first and second frame segments after locating the second repair sleeve structure along second portions of the first and second outer surfaces of the first and second frame segments.

5. The method of claim 2, wherein welding the repair sleeve structures to the frame segments along the gaps comprises:
welding the first repair sleeve structure to the first and second frame segments before locating the second repair sleeve structure along second portions of the first and second outer surfaces of the first and second frame segments; and
welding the second repair sleeve structure to the first and second frame segments after locating the second repair sleeve structure along second portions of the first and second outer surfaces of the first and second frame segments.

6. The method of claim 1, further comprising welding the repair sleeve structures to the frame segments along ends of the repair sleeve structures.

7. The method of claim 6, wherein welding the repair sleeve structures to the frame segments along the gaps comprises:
welding the first repair sleeve structure to the first and second frame segments before locating the second repair sleeve structure along second portions of the first and second outer surfaces of the first and second frame segments; and
welding the second repair sleeve structure to the first and second frame segments after locating the second repair sleeve structure along second portions of the first and second outer surfaces of the first and second frame segments.

8. The method of claim 1, wherein welding the repair sleeve structures to the frame segments along the gaps comprises:
welding the first repair sleeve structure to the first and second frame segments before locating the second repair sleeve structure along second portions of the first and second outer surfaces of the first and second frame segments; and
welding the second repair sleeve structure to the first and second frame segments after locating the second repair sleeve structure along second portions of the first and second outer surfaces of the first and second frame segments.

9. Apparatus for repairing a damaged vehicle frame section, comprising:
a first repair sleeve structure having a first inner surface generally conforming to outer surfaces of first and second frame segments of the damaged frame section; and
a second repair sleeve structure having a second inner surface generally conforming to outer surfaces of first and second frame segments;
wherein the repair sleeve structures are adapted to be located along portions of the outer surfaces of the frame segments with portions of the inner surfaces of the repair sleeve structures engaging the outer surfaces of the first and second frame segments while leaving first and second gaps that expose portions of the first and second outer surfaces of the first and second frame segments between the repair sleeve structures.

10. The apparatus of claim 9, wherein the first and second repair sleeve structures have generally arcuate inner surfaces that generally conform to arcuate outer surfaces of cylindrical frame segments.

11. The apparatus of claim 10, wherein the first and second repair sleeve structures are substantially identical to one another.

12. The apparatus of claim 11, wherein the first and second repair sleeve structures are shaped so as to leave generally straight first and second gaps that extend generally parallel to an axis along which the first and second frame segments are located.

13. The apparatus of claim 10, wherein the first and second repair sleeve structures are shaped so as to leave generally straight first and second gaps that extend generally parallel to an axis along which the first and second frame segments are located.

14. The apparatus of claim 9, wherein the first and second repair sleeve structures are substantially identical to one another.

15. The apparatus of claim 14, wherein the first and second repair sleeve structures are shaped so as to leave generally straight first and second gaps that extend generally parallel to an axis along which the first and second frame segments are located.

16. The apparatus of claim 9, wherein the first and second repair sleeve structures are shaped so as to leave generally straight first and second gaps that extend generally parallel to an axis along which the first and second frame segments are located.

17. A repair weldment for a vehicle frame section, comprising:
a first repair sleeve structure having an inner surface generally conforming to outer surfaces of first and second frame segments of a vehicle frame section, the first repair sleeve structure being located along a portion of the outer surfaces of the first and second frame segments with at least a portion of the inner surface of the first repair sleeve structure engaging the outer surfaces of the first and second frame segments; and
a second repair sleeve structure having an inner surface generally conforming to the outer surfaces of the first and second frame segments, the second repair sleeve structure being located along another portion of the outer surfaces of the first and second frame segments with at least a portion of the inner surface of the second repair sleeve structure engaging the outer surfaces of the first and second frame segments;
wherein the first and second repair sleeve structures are located along portions of the outer surfaces of the frame segments so as to define first and second gaps therebetween and wherein the first and second repair sleeve structures are welded to the first and second frame segments to provide a repair weldment for the vehicle frame section.

18. The repair weldment of claim 17, wherein the first and second repair sleeve structures are welded to one another.

19. The repair weldment of claim 17, wherein the first and second repair sleeve structures are welded to the first and second frame segments along the gaps to provide the repair weldment.

20. The repair weldment of claim 17, wherein the first and second repair sleeve structures are welded to the first and second frame segments along ends of the repair sleeve structures to provide the repair weldment.
